(19) United States
(12) Patent Application Publication
(10) Pub. No.: US 2015/0151629 A1
(43) Pub. Date: Jun. 4, 2015

(54) FUEL STORAGE DEVICE

(71) Applicant: DENSO CORPORATION, Kariya-city (JP)

(72) Inventor: Hidetoshi OOIWA, Anjo-city (JP)

(21) Appl. No.: 14/557,962

(22) Filed: Dec. 2, 2014

(30) Foreign Application Priority Data
Dec. 3, 2013 (JP) 2013-249954

(51) Int. Cl. B60K 15/03; B65D 25/02; B65D 21/08

(52) U.S. Cl. CPC B60K 15/03006; B65D 21/08; B65D 25/02; B60K 2015/0321

(57) ABSTRACT

A fuel storage device includes a fuel tank that stores liquid fuel which is fed through a fill opening of a vehicle. The fuel tank includes a tank case and a separating film. The tank case has a projecting shape in section and defines a two-tiered upper-lower fuel storage chamber in a state where the fuel tank is disposed in the vehicle. The separating film is deformable in the tank case and has impermeability against liquid fuel in the fuel storage chamber. The fuel storage chamber includes a primary fuel storage chamber and a secondary fuel storage chamber. The primary chamber is surrounded partly with the separating film and communicates with the fill opening. The secondary chamber projects toward an upper side of the primary chamber in the state where the fuel tank is disposed in the vehicle and communicates with the fill opening only via the primary chamber.

### CROSS REFERENCE TO RELATED APPLICATION

This application is based on Japanese Patent Application No. 2013-249954 filed on Dec. 3, 2013, the disclosure of which is incorporated herein by reference.

### TECHNICAL FIELD

The present disclosure relates to a fuel storage device including a fuel tank that stores liquid fuel (fuel for an internal combustion engine) fed from a fuel fill opening disposed in a vehicle having the internal combustion engine through a fuel feed pipe (filler pipe).

### BACKGROUND

Conventionally, for a fuel storage device disposed in a vehicle such as an automobile, as illustrated in FIG. 2, to prevent release of evaporated fuel produced in a fuel tank 100 of a vehicle to the atmosphere at the time of feeding fuel to the fuel tank 100, there is proposed an evaporated fuel processor (fuel tank seal system) including a canister CC that can adsorb evaporated fuel generated in a fuel storage chamber 102 in a tank case 101 of the fuel tank 100, a first fuel vapor passage 105 that communicates between the inside (fuel storage chamber 102) of the tank case 101 and the inside (adsorption chamber 104) of a canister case 103 of the canister CC, a second fuel vapor passage 107 that communicates between the adsorption chamber 104 in the canister CC and an intake passage 106 in an intake pipe ID of an engine, a seal valve SV that is disposed at the first fuel vapor passage 105 to close or open the first fuel vapor passage 105, and a purge control valve PV that is disposed at the second fuel vapor passage 107 to close or open the second fuel vapor passage 107 (see, e.g., JP-A-2010-242723 and JP-A-2013-113401).

A fuel pump (not shown) for pressure-feeding fuel into an injector of the internal combustion engine (engine) is disposed in the inside (fuel storage chamber 102) of the tank case 101 of the fuel tank 100. A pressure sensor PS for detecting the pressure (tank internal pressure) in the fuel storage chamber 102, and a temperature sensor (not shown) for detecting the temperature of fuel stored in the fuel storage chamber 102 are disposed in the tank case 101. In a state where the fuel tank 100 is disposed in the vehicle, a cylindrical fuel feed pipe (hereinafter referred to as a filler pipe) 109 is connected to an upper end part of the tank case 101. A fuel feed passage 112 for supplying liquid fuel into the fuel storage chamber 102 through a fuel fill opening 111 of the vehicle is formed in this filler pipe 109. A fuel cap 113 is attached to the fuel fill opening 111 of the filler pipe 109.

The seal valve SV communicates with the fuel storage chamber 102 in the tank case 101 through an ROV and a COV. The ROV is configured to close (fully close) the first fuel vapor passage 105 when a fluid level of liquid fuel in the fuel storage chamber 102 exceeds a first predetermined position at the time of feeding fuel. The COV is configured to close (fully close) the first fuel vapor passage 105 when the fluid level of liquid fuel in the fuel storage chamber 102 exceeds a second predetermined position that is higher than the first predetermined position at the time of feeding fuel.

A communication between the first fuel vapor passage 105 and the fuel storage chamber 102 when the vehicle is overthrown can be prevented by providing the ROV and the COV as described above. Accordingly, liquid fuel does not leak out to the outside through the first fuel vapor passage 105. However, since the conventional fuel tank 100 includes the tank case 101 having a common shape (conventional shape) as illustrated in FIG. 2, there has been an issue that a contact area with the atmosphere, i.e., an area of the fluid level L of liquid fuel in the fuel storage chamber 102 is large and thus the amount of evaporated fuel (fuel vapor) generated is very large at the time of feeding fuel to the fuel tank 100.

Liquid fuel is supplied (fed) from a fuel fill opening through a feed passage into a fuel storage chamber. As a fuel storage device, there is proposed a fuel tank system, in which in accordance with the amount of this liquid fuel with which a fuel chamber is filled, a flexible separating film (hereinafter referred to as a bladder film) that can change the internal volume of the fuel chamber filled with the liquid fuel is accommodated in a tank case of a fuel tank (see e.g., JP-A-2000-229522). In the case of this fuel tank system, the inside of the fuel storage chamber in the tank case can be divided between the fuel chamber and an air chamber by the bladder film. Accordingly, an outflow of fuel vapor from the tank case of the fuel tank can be prevented.

However, to completely divide the fuel storage chamber in the tank case between the fuel chamber and the air chamber by the bladder film, there raises an issue that a method of joining with component parts such as a pressure control valve, a check valve, a filter element, a fuel pump, a pressure sensor, and a temperature sensor, and ensuring of sealing characteristics by a means for sealing between a wall of the tank case and the bladder film become difficult. Thus, in the conventional fuel tank system, there has not been achieved a reduction of evaporated fuel (fuel vapor) produced in the fuel storage chamber of the tank case of the fuel tank with the joining to the component parts attached to the tank case of the fuel tank and the sealing characteristics with respect to the tank case easily ensured.

### SUMMARY

The present disclosure addresses at least one of the above issues. Thus, it is an objective of the present disclosure to provide a fuel storage device that can decrease the amount of evaporated fuel (fuel vapor) generated in a fuel storage chamber of a tank case by reducing an area of a fluid level of liquid fuel in direct contact with a fill opening through which liquid fuel is supplied into the fuel storage chamber of the tank case (area of contact with the atmosphere at the time of feeding fuel) with joining to component parts attached to the tank case of a fuel tank and sealing characteristics with respect to the tank case easily ensured.

To achieve the objective of the present disclosure, there is provided a fuel storage device for a vehicle, including a fuel tank that stores liquid fuel which is fed through a fill opening of the vehicle. The fuel tank includes a tank case and a separating film. The tank case has a projecting shape in section and defines a two-tiered upper-lower fuel storage chamber in a state where the fuel tank is disposed in the vehicle. The separating film is disposed to be deformable in the tank case and has impermeability against liquid fuel in the fuel storage chamber. The fuel storage chamber includes a primary fuel storage chamber and a secondary fuel storage chamber. The primary fuel storage chamber is surrounded partly with the separating film and communicates with the fill opening. The secondary fuel storage chamber is provided to project toward an upper side of the primary fuel storage chamber in the state where the fuel tank is disposed in the vehicle and communicates with the fill opening only via the primary fuel storage chamber.

As a result of this fuel storage device, in a state in which the fuel tank is disposed in a vehicle, there is provided the fuel tank that includes the tank case having a projecting shape in section and forming the upper-lower two-tiered fuel storage chamber. The secondary fuel storage chamber (first fuel storage chamber) that is not in contact with the atmosphere at the time of feeding fuel to the fuel tank is provided for this tank case. Accordingly, with joining to component parts attached to the tank case and sealing characteristics with respect to the tank case easily ensured, there can be reduced an area of the fluid level of liquid fuel in direct contact with the fill opening through which liquid fuel is supplied into the fuel storage chamber of the tank case (area of contact with the atmosphere at the time of feeding fuel to the fuel tank). As a consequence, the amount of evaporated fuel (fuel vapor) generated in the fuel storage chamber of the tank case can be decreased.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram illustrating a fuel tank including a tank case having a projecting shape in section used for an evaporated fuel processor (fuel tank seal system) in accordance with an embodiment; and

FIG. 2 is a diagram illustrating a configuration of an evaporated fuel processor (fuel tank seal system) according to a related art.

### DETAILED DESCRIPTION

An embodiment will be described in detail below with reference to the accompanying drawings.

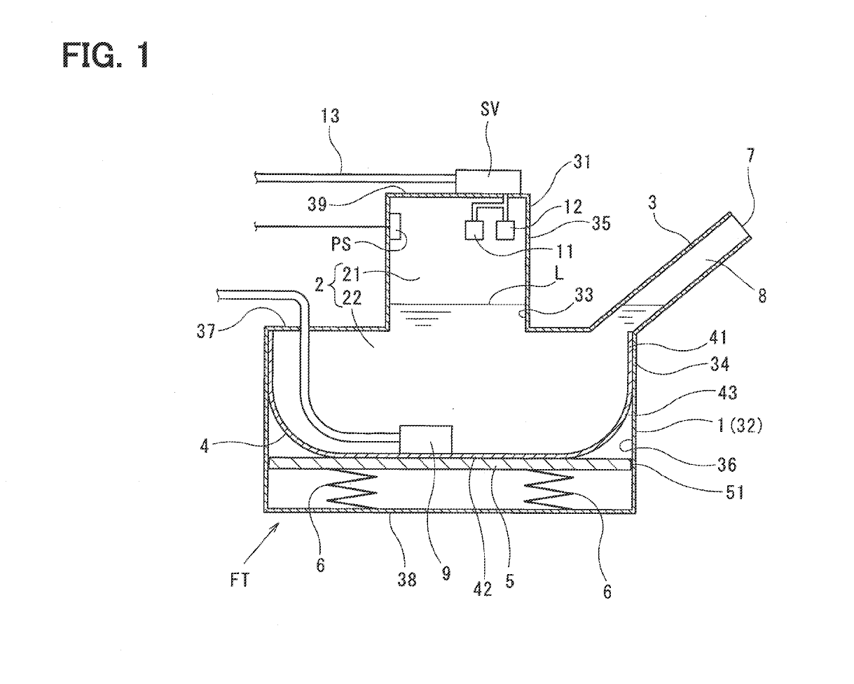

Configuration of the embodiment will be explained below. FIG. 1 illustrates a fuel tank seal system of the embodiment to which a fuel storage device of the present disclosure is applied.

An evaporated fuel processor of the present embodiment includes the fuel tank seal system that can seal a fuel tank FT by closing a seal valve SV disposed between the fuel tank FT and a canister CC. This fuel tank seal system is disposed in a vehicle such as a hybrid automobile that travels with an internal combustion engine (engine) and an electric motor (motor) as its power source. The fuel tank seal system includes the fuel tank FT, the seal valve SV, the canister CC, and a purge control valve PV, and is connected to an intake pipe ID communicating with a combustion chamber of each cylinder of the engine.

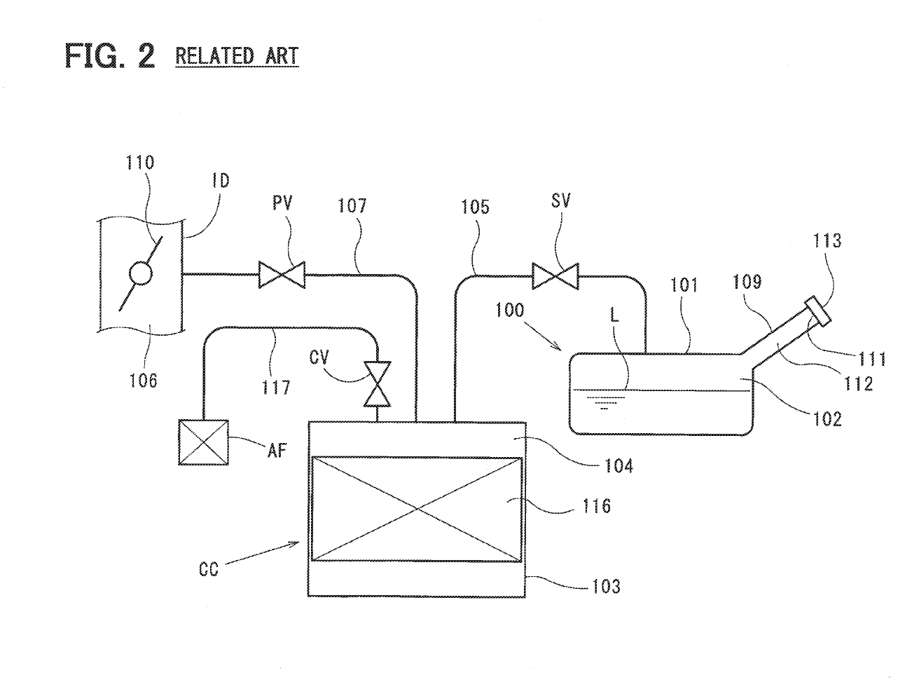

The engine is an engine for vehicle traveling that is disposed in a vehicle such as an automobile, and a gasoline engine that combusts the air-fuel mixture of fuel injected from an injector and air is employed therefor. Accordingly, in the present embodiment, gasoline is used as fuel for the engine. As illustrated in FIG. 2 only for reference, the intake duct (intake pipe) ID defining an intake passage 106 through which intake air that has passed through an air cleaner flows is connected to an intake port of each cylinder of the engine. An exhaust duct (exhaust pipe: not shown) that defines an exhaust passage through which exhaust gas discharged from the combustion chamber flows is connected to an exhaust port of each cylinder of the engine. An intake throttle valve (throttle valve) 110 that adjusts a flow rate of intake air flowing in the intake passage 106 communicating with the combustion chamber of each cylinder of the engine is provided for the intake pipe ID.

The fuel tank seal system is a dedicated canister system for fuel feeding that opens (releases) the seal valve SV at the time of operation of feeding liquid fuel (fuel for the internal combustion engine) into the fuel tank FT and that recovers the evaporated fuel produced in a tank case 1 of the fuel tank FT into the adsorption chamber 104 in the canister case 103 of the canister CC (only for reference). In this dedicated canister system for fuel feeding, at the non-fuel feeding time such as while a vehicle, e.g., an automobile is traveling or when the vehicle is stopped with fuel feeding operation not under way, a closed state of the seal valve SV can be maintained unless the pressure in the tank case 1 of the fuel tank FT rises to a predetermined value or higher. Accordingly, an evaporated fuel recovery load of the canister CC can be reduced, and the evaporated fuel adsorbed and held by an adsorbent 116 accommodated and held in the adsorption chamber 104 of the canister CC can be purged effectively into the intake passage 106 of the intake pipe ID at the non-fuel feeding time (only for reference).

The fuel tank FT includes a fuel tank main body (hereinafter referred to as a tank case) 1 having a projecting shape in section with a predetermined internal volume (e.g., approximately 45 to 60 L at the time of full load of fuel), a filler pipe 3 through which liquid fuel is supplied into a fuel storage chamber 2 in this tank case 1, a separating film (impermeable film against liquid fuel, fuel impermeable film: hereinafter referred to as an impermeable film) 4 provided only on a bottom surface side in the fuel storage chamber 2 to be capable of becoming deformed in the tank case 1, a support table (hereinafter referred to as a slide table) 5 on which the impermeable film 4 is mounted such that a lower surface of the impermeable film 4 is in contact with an upper end surface of the slide table 5, and a weight support means (weight support unit) having a coil spring 6 that supports the weight of liquid fuel in the fuel storage chamber 2 and the weight of the impermeable film 4 via this slide table 5.

In this tank case 1, there is formed the fuel storage chamber 2 that stores the liquid fuel to be supplied to the injector disposed corresponding to each cylinder of the engine and that is upper-lower two-tiered in a state in which the fuel tank FT is disposed in the vehicle (hereinafter referred to as a vehicle disposed state). In the vehicle disposed state of the fuel tank FT, the filler pipe 3 is connected to a predetermined part of the tank case 1. A fuel feed passage 8 through which liquid fuel is supplied from a fuel fill opening 7 of the vehicle into the fuel storage chamber 2 is formed in this filler pipe 3. A fuel cap (not shown) for closing the fuel fill opening 7 is attached to the fuel fill opening 7 of the filler pipe 3.

A fuel pump 9 for pressure-feeding fuel into the injector is disposed in the fuel storage chamber 2 of the tank case 1. The pressure sensor PS for detecting a pressure (tank internal pressure) of a space part above a fluid level of liquid fuel in the fuel storage chamber 2 is disposed in the tank case 1. This pressure sensor PS is attached on an inner surface of a first case (described later) of the tank case 1, and outputs to an ECU a pressure signal corresponding to an upper portion of the projecting part of the fuel storage chamber 2 of the tank case 1 (pressure of a space part in a first fuel storage chamber located on an upper side of an upper end of a second fuel storage chamber described later: tank internal pressure). Details of the fuel tank FT will be described later.

As illustrated in FIG. 2 (only for reference), the canister CC includes the canister case 103 in a rectangular shape in section having a predetermined internal volume. An adsorbent (e.g., activated carbon) 116 that adsorbs the evaporated fuel is accommodated in the adsorption chamber 104 of this canister case 103. A tank (inlet) port, a purge (outlet) port, and an atmosphere port (atmosphere open hole) are formed respectively at the canister case 103. A vapor pipe (first passage pipe), in which a first fuel vapor passage (first passage) 13 is formed, is connected to the tank port of the canister case 103. A purge pipe (second passage pipe), in which a second fuel vapor passage (second passage: not shown) is formed, is connected to the purge port.

The purge pipe is connected to a downstream side of the throttle valve 110 in an intake air flow direction (intake port side of the engine). The purge control valve PV for adjusting the purged amount of evaporated fuel (evaporative gas, purge gas) is provided at the purge pipe. An atmosphere introduction pipe including an atmosphere introduction passage (third passage) 117 is connected to the atmosphere port of the canister case 103. An air filter AF for filtering air flowing into the adsorption chamber 104 in the canister case 103 of the canister CC is provided at an atmosphere introduction port of this atmosphere introduction pipe. A canister control valve CV that closes the atmosphere open hole of the canister CC if needed is provided at the atmosphere introduction pipe.

The seal valve SV for closing or opening the first fuel vapor passage 13 formed in the vapor pipe is provided at the vapor pipe. This seal valve SV includes a valve body that is provided at the first fuel vapor passage 13 and includes a valve seat having a valve hole which communicates with the first fuel vapor passage 13, formed to pass therethrough, a valving element (valve) that is disposed in this valve body and is engaged with or disengaged from the valve seat to close or open the valve hole, and an electromagnetic actuator (linear solenoid) that drives this valve to open or close.

The seal valve SV variably controls in stages an opening area of the first fuel vapor passage 13 (valve hole) in accordance with the electric power to the electromagnetic actuator between a fully-closed position at which the valve is engaged with the valve seat to fully close the valve hole, and a fully-open position at which the valve is disengaged form the valve seat to fully open the valve hole. The electromagnetic actuator is electrically-connected to an external power (battery) disposed in a vehicle such as an automobile through an electromagnetic valve drive circuit that is electronically controlled by an engine control unit (electronic control unit: hereinafter referred to as an ECU) which is an external control circuit.

The seal valve SV is configured to communicate with the fuel storage chamber 2 of the tank case 1 via an ROV 11 and a COV 12. The ROV 11 is configured to close (fully close) the first fuel vapor passage 13 when a fluid level L of liquid fuel in the fuel storage chamber 2 exceeds a first predetermined position at the time of feeding fuel. The COV 12 is configured to close (fully close) the first fuel vapor passage 13 when the fluid level L of liquid fuel in the fuel storage chamber 2 exceeds a second predetermined position that is higher than the first predetermined position at the time of feeding fuel. A communication between the first fuel vapor passage 13 and the fuel storage chamber 2 when the vehicle is overthrown can be prevented by providing the ROV 11 and the COV 12 as described above. Accordingly, liquid fuel does not leak out to the outside through the first fuel vapor passage 13.

In the present embodiment, while a hybrid automobile including the fuel tank seal system is traveling with a motor, negative pressure is not generated in the intake passage 106 of the intake pipe ID. Thus, the evaporated fuel adsorbed by the adsorbent 116 in the adsorption chamber 104 in the canister case 103 of the canister CC cannot be fed into the intake passage 106. Accordingly, in order to prevent the adsorbent 116 in the canister CC from adsorbing too much evaporated fuel and overflowing with evaporated fuel, the seal valve SV disposed at the first fuel vapor passage 13 between the fuel storage chamber 2 in the tank case 1 of the fuel tank FT and the adsorption chamber 104 in the canister case 103 of the canister CC is closed (fully closed) to close (seal) the communication between the fuel tank FT and the canister CC.

In the fuel tank seal system, by a driver operating a fill opening lever (not shown) including an opening switch (not shown) and so forth at the time of feeding fuel into the fuel tank FT, an opening signal is inputted into the ECU that controls the fuel tank seal system, and the ECU, into which the opening signal is inputted, opens (fully opens) the seal valve SV. Accordingly, the pressure of the fuel tank FT can be reduced to the atmospheric pressure, and thus even though the fuel cap is removed, there can be prevented a release of evaporated fuel to the outside air (atmosphere) from the fuel tank FT through the fuel fill opening 7.

Details of the fuel tank FT of the present embodiment will be described briefly with reference to FIG. 1. The fuel tank FT includes the tank case 1, the filler pipe 3 through which to supply liquid fuel introduced from the fuel fill opening 7 into the fuel storage chamber 2 of the tank case 1, the impermeable film 4 disposed only on a bottom surface side of liquid fuel in the fuel storage chamber 2 to form the bottom surface of the fuel storage chamber 2, the slide table 5 that can be displaced up or down (reciprocated) in the vertical direction of the tank case 1, and the weight support means including the coil spring 6 that produces urging force for urging upward in a vehicle disposed state against the weight of liquid fuel in the fuel storage chamber 2 and the weight of the impermeable film 4.

The tank case 1 is formed from synthetic resin or metal. The fuel storage chamber 2 of this tank case 1 includes a second fuel storage chamber (primary fuel storage chamber) 22 that communicates with the fuel fill opening 7, which opens at the upstream end of the filler pipe 3, through the fuel feed passage 8 of the filler pipe 3, and a first fuel storage chamber (secondary fuel storage chamber) 21 that is disposed to project on an upper side of this second fuel storage chamber 22 in a vehicle disposed state and communicates with the fuel fill opening 7 only through the second fuel storage chamber 22 and the fuel feed passage 8. The second fuel storage chamber 22 is a volume variable chamber (first hollow part) whose internal volume can vary according to a change of internal volume of the impermeable film 4, and communicates with the fuel feed passage 8 of the filler pipe 3. The first fuel storage chamber 21 is a volume invariable chamber (second hollow part) configured such that the fluid level L of liquid fuel is constantly located as a result of the liquid fuel being pushed up by the urging force of the coil spring 6, and communicates with the fuel feed passage 8 only via the second fuel storage chamber 22.

The tank case 1 has a projecting shape in section includes a first case 31 having therein the first fuel storage chamber 21, a second case 32 that is disposed on a lower side of this first case 31 in the vertical direction in a vehicle disposed state and defines the second fuel storage chamber 22 between the second case 32 and an inner surface of the impermeable film 4, and a communication part (hereinafter referred to as a communicating port) 33 communicating between the first fuel storage chamber 21 and the second fuel storage chamber 22. The fuel fill opening 7 opens at an upper end of the filler pipe 3 connected directly only to the second case 32 of the tank case 1 in a vehicle disposed state.

The second case 32 is a region of the tank case 1 having a projecting shape that constitutes a lower portion of the hollow projecting part, and includes a cylindrical first peripheral wall 34 that surrounds the first fuel storage chamber 21 in its circumferential direction. The first case 31 is a region of the tank case 1 having a projecting shape that constitutes an upper portion of the hollow projecting part, and includes a cylindrical second peripheral wall 35 that is disposed on an upper side of the first peripheral wall 34 in the vertical direction in a vehicle disposed state to surround the second fuel storage chamber 22 in its circumferential direction. The tank case 1 is configured such that a cross-sectional area of the second peripheral wall 35 in a horizontal direction is smaller than a cross-sectional area of the first peripheral wall 34 in a horizontal direction in the vehicle disposed state.

The second case 32 includes an angular cylindrical guide surface 36 extending in a direction in which the slide table 5 moves up or down on an inner wall surface of its first peripheral wall 34. This guide surface 36 has a function as a guide for slidably guiding the slide table 5 in a direction in which the slide table 5 moves up or down. The second case 32 includes a first upper wall 37 that closes an upper end side of the first peripheral wall 34 and closes a lower end side of the second peripheral wall 35, and a bottom wall 38 that is disposed to be opposed to an inner surface of this first upper wall 37 and accommodates the impermeable film 4, the slide table 5, and the coil springs 6 between the bottom wall 38 and the first upper wall 37. The first case 31 includes a second upper wall 39 that closes an upper end side of the second peripheral wall 35.

An opening peripheral edge part that surrounds in the circumferential direction the communicating port 33 having a rectangular shape in cross-section is provided on an inner surface of a central part of the first upper wall 37.

The communicating port 33 is formed to pass through the first upper wall 37 in its thickness direction, and communicates between the first fuel storage chamber 21 and the second fuel storage chamber 22. This communicating port 33 is provided at a higher position than an upper end of the second fuel storage chamber 22 to communicate with the first fuel storage chamber 21. When liquid fuel is fed into the first fuel storage chamber 21, the liquid fuel flows into the communicating port 33 from the first fuel storage chamber 21. The second fuel storage chamber 22 is provided at a lower position than the upper end of the first fuel storage chamber 21 and the communicating port 33, and communicates with the first fuel storage chamber 21 through the communicating port 33. When liquid fuel is fed into the first fuel storage chamber 21, the liquid fuel flows into this second fuel storage chamber 22 from the communicating port 33.

The impermeable film 4 is formed from a flexible material (e.g., synthetic resin) that can be elastically deformed corresponding to a change of the weight of liquid fuel in the fuel storage chamber 2 of the tank case 1. The impermeable film 4 includes an angularly annularly-shaped outer peripheral brim part 41 that is attached angularly annularly on an inner surface of the first peripheral wall 34 of the second case 32 near its upper end, a bottom surface part 42 that is attached on an upper end surface of the slide table 5 using a means such as welding or adhesion in a state of surface contact with the upper end surface of the slide table 5, and an angular cylindrical lateral surface part 43 connecting together the outer peripheral brim part 41 and the bottom surface part 42. The impermeable film 4 is mounted on the slide table 5 such that the bottom surface part 42 which is a lower surface of the film 4 is in surface contact with an upper end surface of the slide table 5. The outer peripheral brim part 41 of the impermeable film 4 is sealed air-tightly close to the upper end of the first peripheral wall 34 of the second case 32. The lateral surface part 43 of the impermeable film 4 includes an outwardly projecting bent surface.

The slide table 5 is a weight receiving member for receiving the weight of liquid fuel in the fuel storage chamber 2 of the tank case 1 and the weight of the impermeable film 4 together with the coil spring 6 of the weight support means. This slide table 5 is attached on the impermeable film 4 using a means such as welding or adhesion such that the lower surface of the impermeable film 4 (bottom surface part 42) is in surface contact with an upper end surface of the slide table 5 in its thickness direction. The slide table 5 includes an angularly annularly-shaped sliding part (outer peripheral end surface) 51 that is supported slidably by the guide surface 36 provided on an inner wall surface of the second case 32 of the tank case 1 such that the slide table 5 can be displaced in a direction in which the slide table 5 moves up or down. Accordingly, the bottom surface part 42 of the impermeable film 4 and the slide table 5 can smoothly be displaced in a direction in which the slide table 5 moves up or down without being inclined relative to a horizontal direction perpendicular to the vertical direction of the tank case 1 that is a direction in which the slide table 5 moves up or down.

The weight support means includes the coil springs 6 that give the urging force for urging against the weight of liquid fuel in the fuel storage chamber 2 of the tank case 1 and the weight of the impermeable film 4 toward an upper side in the vertical direction in a vehicle disposed state, i.e., toward an upward side in a direction in which the bottom surface part 42 of the impermeable film 4 and the slide table 5, which define (restrict) the bottom surface of the second fuel storage chamber 22, move up or down, such that the fluid level L of liquid fuel is located in the first fuel storage chamber 21 formed in the upper portion (first case 31) of the projecting part of the tank case 1 even if at least the weight of liquid fuel in the fuel storage chamber 2 is reduced to a preset value (the remaining amount of liquid fuel is at least 5 to 10 L). The coil springs 6 are resilient members in a coiled shape having a metal wire spirally wound, and are disposed between the second case 32 of the tank case 1 and the slide table 5. One ends (upper ends) of these coil springs 6 are held by or engaged with the lower end surface of the slide table 5, and the other ends (lower ends) of the coil springs 6 are held by or engaged with a bottom surface of the bottom wall 38 of the second case 32 of the tank case 1.

Operation of the fuel tank FT of the present embodiment will be described briefly with reference to FIG. 1.

When the fuel cap is removed from the fuel fill opening 7 and fuel is fed into the fuel storage chamber 2 of the tank case 1, first, the fuel flows through the fuel feed passage 8 of the filler pipe 3 into the second fuel storage chamber 22 defined between a surface of the first upper wall 37 of the second case 32 of the tank case 1 and an inner surface of the impermeable film 4. Accordingly, the bottom surface part 42 of the impermeable film 4 and the slide table 5 are displaced toward a lower side in the vertical direction in a vehicle disposed state, i.e., toward a downward side in a direction in which the slide table 5 moves up or down by the weight of liquid fuel in the fuel storage chamber 2 and the weight of the impermeable film 4 against the urging force of the coil springs 6. As a result, the bottom surface part 42 of the impermeable film 4 and the slide table 5 are positioned on the lowest side.

In this case, when the fuel continues to be fed into the fuel storage chamber 2 of the tank case 1, the internal volume of the impermeable film 4 is maximized so that the liquid fuel overflows the second fuel storage chamber 22 to flow from the second fuel storage chamber 22 into the communicating port 33 that is provided at a higher position than the upper end of the second fuel storage chamber 22. When the fuel further continues to be fed into the fuel storage chamber 2 of the tank case 1, the liquid fuel flows through the communicating port 33 into the first fuel storage chamber 21 provided at a higher position than the upper end of the second fuel storage chamber 22 and the communicating port 33. When the liquid fuel is fed into the fuel storage chamber 2 of the tank case until the chamber 2 is filled up, as illustrated in FIG. 1, the fluid level L of liquid fuel is located in the first fuel storage chamber 21.

When fuel feeding into the fuel storage chamber 2 of the tank case 1 is ended and the fuel cap is attached to the fuel fill opening 7 to drive the vehicle, the liquid fuel is consumed and the weight of liquid fuel that remains in the fuel storage chamber 2 of the tank case is reduced. Accordingly, in accordance with this reduction of the weight of liquid fuel, the bottom surface part 42 of the impermeable film 4 and the slide table 5 are pushed up by the urging force of the coil springs 6 toward an upper side in the vertical direction in a vehicle disposed state, i.e., toward an upward side in a direction in which the slide table 5 moves up or down. In this case, although the internal volume of the impermeable film 4 (internal volume of the second fuel storage chamber 22) is between the maximum volume and the minimum volume, the fluid level L of liquid fuel in the first fuel storage chamber 21 is still located in the first fuel storage chamber 21. As a result, the fluid level L of liquid fuel in the first fuel storage chamber 21 does not communicate with the fuel fill opening 7 and the fuel feed passage 8 of the filler pipe 3.

Thus, even when the fuel cap is removed from the fuel fill opening 7 in this state and fuel is fed into the fuel storage chamber 2 of the tank case 1, the fluid level L of liquid fuel in the first fuel storage chamber 21 is not open to the atmosphere so that a contact area between the fluid level L of liquid fuel in the fuel storage chamber 2 of the tank case 1 and the atmosphere can be reduced.

As a result, the amount of evaporated fuel (fuel vapor) produced in the fuel storage chamber 2 of the tank case 1 can be decreased. This state is ensured until the weight of liquid fuel in the fuel storage chamber 2 of the tank case 1 reaches the preset value (the remaining amount of liquid fuel is at least 5 to 10 L).

Effects of the embodiment will be described below. As described above, the fuel tank FT used for the fuel tank seal system of the present embodiment includes the tank case 1 having a projecting shape in section and defining the first and second fuel storage chambers 21, 22 which are upper-lower two-tiered in a vehicle disposed state. The second fuel storage chamber 22 communicates with the fuel feed passage 8 of the filler pipe 3. The first fuel storage chamber 21 communicates with the fuel feed passage 8 only via the second fuel storage chamber 22. The tank case 1 includes the first case 31 having therein the first fuel storage chamber 21, and the second case 32 having the second fuel storage chamber 22 between the second case 32 and the inner surface of the impermeable film 4. The tank case 1 is configured such that a cross-sectional area of the second peripheral wall 35 of the first case 31 in a horizontal direction is smaller than a cross-sectional area of the first peripheral wall 34 of the second case 32 in a horizontal direction in the vehicle disposed state.

The first fuel storage chamber 21 which is not in contact with the atmosphere at the time of feeding fuel into the fuel tank FT is formed in the first case 31 of the tank case 1. Accordingly, joining to component parts (e.g., pressure sensor PS) attached to the tank case 1 and sealing characteristics with respect to the upper end of the first peripheral wall 34 of the second case 32 of the tank case 1 are easily ensured, and at the same time, an area of the fluid level of liquid fuel that is in direct contact with the fuel fill opening 7 through which the liquid fuel is introduced into the fuel storage chamber 2 of the tank case 1 (area of contact with the atmosphere at the time of feeding fuel) can be decreased. As a result, the fuel tank FT of the present embodiment can reduce the amount of evaporated fuel (fuel vapor) produced in the fuel storage chamber 2 of the tank case 1.

The fuel tank FT of the present embodiment includes the tank case 1 having a projecting shape in section, and the impermeable film 4 that is disposed to be deformable in the tank case 1 and has impermeability against the liquid fuel in the fuel storage chamber 2. Because this impermeable film 4 is disposed only on a bottom surface side of liquid fuel in the fuel storage chamber 2 to form a bottom surface of, particularly, the second fuel storage chamber 22 of the fuel storage chamber 2, the component parts (e.g., fuel pump 9 and pressure sensor PS) disposed in the inside (fuel storage chamber 2) of the tank case 1 can be arranged not to be in contact with the impermeable film 4. Accordingly, consideration for joining between the component parts attached to the tank case 1 and the impermeable film 4, and securing of sealing characteristics between the tank case 1 and the impermeable film 4 is made unnecessary.

The fuel tank FT of the present embodiment includes the slide table 5 that receives the weight of liquid fuel in the fuel storage chamber 2 and the weight of the impermeable film 4 and can ascend or descend (move) in the vertical direction of the tank case 1, and the weight support means for supporting the weight of liquid fuel in the fuel storage chamber 2 and the weight of the impermeable film 4 via this slide table 5. The weight support means includes the coil springs 6 that give (generate) the urging force for urging against the weight of liquid fuel in the fuel storage chamber 2 of the tank case 1 and the weight of the impermeable film 4 toward an upper side in the vertical direction in a vehicle disposed state, i.e., toward an upward side in a direction in which the bottom surface part 42 of the impermeable film 4 and the slide table 5, which define (restrict) the bottom surface (lowest surface of liquid fuel) of the second fuel storage chamber 22 of the fuel storage chamber 2, move up or down, such that the fluid level L of liquid fuel is located in the first fuel storage chamber 21 formed in the upper portion (first case 31) of the projecting part of the tank case 1 even if at least the weight of liquid fuel in the fuel storage chamber 2 is reduced to a preset value (the remaining amount of liquid fuel is at least 5 to 10 L). Accordingly, when the weight of liquid fuel in the fuel storage chamber 2 is reduced, the slide table 5 is pushed up (moves up) toward an upper side in the vertical direction in a vehicle disposed state, i.e., toward an upward side in a direction in which the slide table 5 moves up or down by the urging force of the coil springs 6. As a result, the bottom surface of the second fuel storage chamber 22 restricted by the bottom surface part 42 of the impermeable film 4 rises. Consequently, even if at least the weight (fuel weight) of liquid fuel in the fuel storage chamber 2 is reduced to a preset value, the fluid level L of liquid fuel is located constantly in the first fuel storage chamber 21 of the tank case 1. Thus, not only in a case of the fuel storage chamber 2 in this tank case 1 being filled up with liquid fuel, but also in a state of at least the weight of liquid fuel in the fuel storage chamber 2 being reduced to a preset value, a small contact area with the atmosphere at the time of feeding fuel into the fuel tank FT can be maintained. As a consequence, there can be reduced the amount of evaporated fuel (fuel vapor) produced in the fuel storage chamber 2 of the tank case 1.

Modifications to the above embodiment will be described below. In the present embodiment, as a fill opening of a vehicle, there is provided the fuel fill opening 7 that opens at the upper end portion of the filler pipe 3 which is directly connected only to the second case 32 of the tank case 1 in a state in which the fuel tank FT is disposed in the vehicle. Alternatively, as a fill opening of a vehicle, there may be provided a fuel fill opening that opens at the upper end portion of the second case 32 in a state in which the fuel tank FT is disposed in the vehicle. In addition, the seal valve SV, the ROV 11, and the COV 12 do not need to be provided for the fuel tank FT. In this case, there is provided an evaporated fuel processor including the canister CC, the first fuel vapor passage 13 (105), the second fuel vapor passage 107, and the purge control valve PV. In a case where the seal valve SV for closing or opening the first fuel vapor passage 13 (105) used for the fuel tank seal system is attached to the fuel tank FT, instead of the ROV 11 and the COV 12, there may be disposed a forward direction (first) relief valve having a check-valve structure for opening a first valve hole provided at the first fuel vapor passage 13 when the pressure in the fuel storage chamber 2 of the tank case 1 becomes much higher than the pressure in the canister case 103 of the canister CC, and a backward direction (second) relief valve having a check-valve structure for opening a second valve hole provided at the first fuel vapor passage 13 when the pressure in the fuel storage chamber 2 of the tank case 1 becomes much lower than the pressure in the canister case 103 of the canister CC.

In the present embodiment, for the weight support means for supporting the weight of liquid fuel in the fuel storage chamber of the tank case and the weight of the separating film via the support table, there are employed the coil springs 6 that give the urging force for urging upward in a state in which the fuel tank FT is disposed in the vehicle against the weight of liquid fuel in the fuel storage chamber 2 and the weight of the impermeable film 4. Alternatively, as the weight support means, there may be employed a resilient member that gives the urging force for urging upward in a state in which the fuel tank FT is disposed in the vehicle against the weight of liquid fuel in the fuel storage chamber 2 and the weight of the impermeable film 4. In addition, at least one coil spring 6 may be provided. Instead of the spring in a coiled shape, a plate spring may be used for the weight support means (resilient member).

For the internal combustion engine (engine), a multiple-cylinder diesel engine may be employed instead of a multiple-cylinder gasoline engine. The present disclosure may be applied to a single-cylinder engine. Alcohol blended fuel in which gasoline and alcohol fuel such as ethanol or methanol, or gasoline and alcohol fuel are mixed at an arbitrary rate may be used as fuel for the internal combustion engine (engine). Additionally, liquefied gas fuel or diesel fuel may be employed as fuel for the internal combustion engine (engine).

To sum up, the fuel storage device in accordance with the above embodiment can be described as follows.

A fuel storage device for a vehicle includes a fuel tank FT that stores liquid fuel which is fed through a fill opening 7 of the vehicle. The fuel tank FT includes a tank case 1 and a separating film 4. The tank case 1 has a projecting shape in section and defines a two-tiered upper-lower fuel storage chamber 2 in a state where the fuel tank FT is disposed in the vehicle. The separating film 4 is disposed to be deformable in the tank case 1 and has impermeability against liquid fuel in the fuel storage chamber 2. The fuel storage chamber 2 includes a primary fuel storage chamber 22 and a secondary fuel storage chamber 21. The primary fuel storage chamber 22 is surrounded partly with the separating film 4 and communicates with the fill opening 7. The secondary fuel storage chamber 21 is provided to project toward an upper side of the primary fuel storage chamber 22 in the state where the fuel tank FT is disposed in the vehicle and communicates with the fill opening 7 only via the primary fuel storage chamber 22. The separating film 4 may be provided only on a bottom-surface side of liquid fuel in the fuel storage chamber 2 to form a bottom surface of the fuel storage chamber 2. The separating film 4 may be formed from a flexible material that is deformable at least corresponding to a change of weight of liquid fuel in the fuel storage chamber 2. The primary fuel storage chamber 22 may have a function as a volume variable chamber whose internal volume changes when the separating film 4 is deformed in the tank case 1. The fuel tank FT may include a pressure sensor PS that outputs a signal corresponding to an inner pressure of the tank case 1. The fuel tank FT may include a support table 5 that receives weight of liquid fuel in the fuel storage chamber 2 and weight of the separating film 4 and that is capable of moving up or down in an upper-lower direction of the tank case 1. The separating film 4 may be mounted on the support table 5 with a lower surface of the separating film 4 in surface contact with an upper end surface of the support table 5. The fuel tank FT may include a weight support unit 6 that supports weight of liquid fuel in the fuel storage chamber 2 and weight of the separating film 4 via the support table 5. The weight support unit 6 may include a resilient member 6 that gives urging force for urging against the weight of liquid fuel in the fuel storage chamber 2 and the weight of the separating film 4 toward the upper side in the state where the fuel tank FT is disposed in the vehicle, such that a fluid level L of liquid fuel is located in the secondary fuel storage chamber 21 even when at least the weight of liquid fuel in the fuel storage chamber 2 is reduced to a predetermined value. The tank case 1 may include a first case 31 that includes therein the secondary fuel storage chamber 21, a second case 32 that is located on a lower side of the first case 31 in a vertical direction in the state where the fuel tank FT is disposed in the vehicle and that includes the primary fuel storage chamber 22 between the second case 32 and an inner surface of the separating film 4, and a communication part 33 that communicates between the secondary fuel storage chamber 21 and the primary fuel storage chamber 22. The communication part 33 may be located at a higher position than an upper end of the primary fuel storage chamber 22 and may communicate with the primary fuel storage chamber 22. When liquid fuel is fed into the primary fuel storage chamber 22, liquid fuel flows from the primary fuel storage chamber 22 into the communication part 33. The secondary fuel storage chamber 21 may be located at a higher portion than an upper end of the primary fuel storage chamber 22 and the communication part 33 or an upper end of the communication part 33, and may communicate with the primary fuel storage chamber 22 through the communication part 33. When liquid fuel is fed into the primary fuel storage chamber 22, liquid fuel flows from the communication part 33 into the secondary fuel storage chamber 21.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fuel storage device for a vehicle, comprising:
a fuel tank that stores liquid fuel which is fed through a fill opening of the vehicle and that includes:
a tank case that has a projecting shape in section and defines a two-tiered upper-lower fuel storage chamber in a state where the fuel tank is disposed in the vehicle; and
a separating film that is disposed to be deformable in the tank case and has impermeability against liquid fuel in the fuel storage chamber, wherein the fuel storage chamber includes:
a primary fuel storage chamber that is surrounded partly with the separating film and communicates with the fill opening; and
a secondary fuel storage chamber that is provided to project toward an upper side of the primary fuel storage chamber in the state where the fuel tank is disposed in the vehicle and that communicates with the fill opening only via the primary fuel storage chamber.

2. The fuel storage device according to claim 1, wherein the separating film is provided only on a bottom-surface side of liquid fuel in the fuel storage chamber to form a bottom surface of the fuel storage chamber.

3. The fuel storage device according to claim 1, wherein the separating film is formed from a flexible material that is deformable at least corresponding to a change of weight of liquid fuel in the fuel storage chamber.

4. The fuel storage device according to claim 1, wherein the primary fuel storage chamber has a function as a volume variable chamber whose internal volume changes when the separating film is deformed in the tank case.

5. The fuel storage device according to claim 1, wherein the fuel tank includes a pressure sensor that outputs a signal corresponding to an inner pressure of the tank case.

6. The fuel storage device according to claim 1, wherein the fuel tank includes a support table that receives weight of liquid fuel in the fuel storage chamber and weight of the separating film and that is capable of moving up or down in an upper-lower direction of the tank case.

7. The fuel storage device according to claim 6, wherein the separating film is mounted on the support table with a lower surface of the separating film in surface contact with an upper end surface of the support table.

8. The fuel storage device according to claim 6, wherein the fuel tank includes a weight support unit that supports weight of liquid fuel in the fuel storage chamber and weight of the separating film via the support table.

9. The fuel storage device according to claim 8, wherein the weight support unit includes a resilient member that gives urging force for urging against the weight of liquid fuel in the fuel storage chamber and the weight of the separating film toward the upper side in the state where the fuel tank is disposed in the vehicle, such that a fluid level of liquid fuel is located in the secondary fuel storage chamber even when at least the weight of liquid fuel in the fuel storage chamber is reduced to a predetermined value.

10. The fuel storage device according to claim 1, wherein the tank case includes:
a first case that includes therein the secondary fuel storage chamber;
a second case that is located on a lower side of the first case in a vertical direction in the state where the fuel tank is disposed in the vehicle and that includes the primary fuel storage chamber between the second case and an inner surface of the separating film; and
a communication part that communicates between the secondary fuel storage chamber and the primary fuel storage chamber.

11. The fuel storage device according to claim 10, wherein:
the communication part is located at a higher position than an upper end of the primary fuel storage chamber and communicates with the primary fuel storage chamber; and
when liquid fuel is fed into the primary fuel storage chamber, liquid fuel flows from the primary fuel storage chamber into the communication part.

12. The fuel storage device according to claim 10, wherein:
the secondary fuel storage chamber is located at a higher portion than an upper end of the primary fuel storage chamber and the communication part or an upper end of the communication part, and communicates with the primary fuel storage chamber through the communication part; and
when liquid fuel is fed into the primary fuel storage chamber, liquid fuel flows from the communication part into the secondary fuel storage chamber.
